(19) United States
(12) Patent Application Publication
(10) Pub. No.: US 2006/0159052 A1
(43) Pub. Date: Jul. 20, 2006

(54) Space division multiplex wireless communication system, device and method for the same

(76) Inventors: Shouichi Koga, Lizuka (JP); Junji Kondo, Tagawa-Gun (JP)

Correspondence Address: WENDEROTH, LIND & PONACK L.L.P., 2033 K. STREET, NW, SUITE 800, WASHINGTON, DC, 20006, US

(21) Appl. No.: 10/563,634

(22) PCT Filed: Nov. 11, 2004
(86) PCT No.: PCT/JP04/17130

§ 371 Date: Jan. 6, 2006

(51) Int. Cl. H04B 7/216

(52) U.S. Cl. 370/335

(57) ABSTRACT

A wireless communication system comprises a base station (4) and terminals (1)-(3). The base station (4) and the terminals (1)-(3) perform a space division multiplex wireless transmission. Each of the base station (4) and the terminals (1)-(3) comprises a multi-beam antenna for a space division multiplex. A beam pattern formed by the multi-beam antenna of the base station (4) is orthogonalized based on transfer function values of a radio-wave-propagation characteristic formed between antenna elements of the multi-beam antenna of the base station (4) and antenna elements of multi-beam antenna of the terminals (1)-(3).

### TECHNICAL FIELD

The present invention relates to a wireless communication system that performs space division wireless point-to-multipoint communications using multi-beam antennas and arts related thereto.

### BACKGROUND ART

Conventionally, a frequency division multiplex (FDM), a time division multiplex (TDM), and a code division multiplex (CDM) are well known.

According to these multiplexing techniques, a plurality of items of information is composed into output data, and the output data is transmitted in a wireless manner. When information multiplicity thereof increases, a necessary radio frequency bandwidth becomes very wide. Therefore, when an available bandwidth is not sufficiently broad, frequency easily runs short.

According to a space division multiplex (SDM), each of a transmitting terminal and a receiving terminal is provided with a plurality of antennas elements, and transmitted data is multiplexed using the same frequency without increasing a radio frequency bandwidth. A MIMO (Multiple Input Multiple Output) is a typical communication technique of the SDM. According to the MIMO, as disclosed in document 1 (published Japanese Patent Application Laid-Open No. H10-178367), a plurality of propagation paths are formed between a transmitting terminal and a receiving terminal, and items of information transmitted via the plurality of propagation paths basically differ from each other.

To be more specific, each of a plurality of directional antennas is null-steered, radio signals are spatially divided for every propagation path, and point-to-point multiplex communications are performed.

When radio signals are null-steered, a main beam of a beam pattern is adjusted to point toward a desired wave-arriving direction, and a null point of the beam pattern is adjusted to point toward an un-desired wave-arriving direction.

FIG. 17(a) shows an example of the beam pattern that a two element array antenna is used. In the example of FIG. 17(a), a main beam 100 points toward a desired wave-arriving direction, and a null point 101 points toward an undesired wave-arriving direction.

FIG. 17(b) shows an example of the beam pattern in a case where a six element array antenna is used. Also, in the example of FIG. 17(b), a main beam 100 points toward a desired wave-arriving direction, and a null point 101 points toward an un-desired wave-arriving direction. Thus, radio signals are null-steered in accordance with a plurality of propagation paths, thereby a beam pattern can be orthogonalized.

According to the MIMO, a multi-beam antenna is used as a directional antenna, directivity of the directional antenna is controlled calculating a channel matrix H whose matrix elements are transfer function values of a radio-wave-propagation characteristic. The radio-wave-propagation characteristic is a characteristic between a plurality of antenna elements of a transmitting terminal and a plurality of antenna elements of a receiving terminal.

Document 2 (G. J. Foschini work, Bell Labs Technical Journal, Vol. 1, No. 2, Autumn 1996, pp 41-59) discloses a BLAST (Bell Labs Layered Space-Time) method proposed by Foschini in the Bell Labs. According to the BLAST method, in a receiving terminal, general inverse-matrix calculations of a channel matrix H is repeatedly performed in an order from a weighting vector with the smallest norm. The repeated calculation earns effects of space diversity in addition to effects of space division multiplex communications.

Document 3 (published Japanese Patent Application Laid-Open No. 2001-237751) discloses a technique for controlling weight of a multi-beam antenna. For this controlling, a transmitting terminal and a receiving terminal perform eigenvalue calculations of a channel matrix H to obtain eigenvectors. Furthermore, transmitting power control based on the so-called water filling rule is combined; thereby high efficient power utilization can be obtained in addition to effects of space division multiplex communications.

However, the conventional techniques realize point-to-point multiplex communications. Therefore, when there is few propagation paths formed between antennas of the transmitting terminal and antennas of the receiving terminal, multiplicity is limited in accordance with the number of propagation paths. Regardless of the number of antenna elements of the antennas, this limitation cannot be avoided.

According to the conventional techniques, under environment with few propagation paths, frequency utilization efficiency becomes low.

A first object of the present invention is to provide a wireless communication system that earns high efficiency in frequency utilization under an environmental condition with few propagation paths formed between a base station and terminals.

A second object of the present invention is to provide a technique for orthogonalizing a beam pattern of a multi-beam antenna of the base station.

A third object of the present invention is to provide a technique for quasi-orthogonalizing beam patterns formed by multi-beam antennas of the terminals.

### DISCLOSURE OF INVENTION

A first aspect of the present invention provides a wireless communication system comprising: a base station; a plurality of terminals; and a control unit, wherein the base station and each of the plurality of terminals are operable to simultaneously perform space division multiplex wireless transmission of information using a same frequency, wherein at least one of the plurality of terminals communicates with the base station via a plurality of propagation paths, wherein the base station comprises a base station multi-beam antenna used for the space division multiplex wireless transmission, wherein the base station multi-beam antenna comprises a plurality of base station antenna elements, wherein each of the plurality of terminals comprises a terminal multi-beam antenna used for the space division multiplex wireless transmission, wherein the terminal multi-beam antenna comprises a plurality of terminal antenna elements, and wherein the control unit is operable to orthogonalize a beam pattern of the base station multi-beam antenna, thereby controlling the space division multiplex wireless transmission.

With this structure, the control unit can orthogonalize the beam patterns of the plurality of base station antenna elements of the base station multi-beam antenna, thereby performing space division wireless point-to-multipoint communications. In particular, frequency utilization efficiency can be improved under environment with few propagation paths.

A second aspect of the present invention provides a wireless communication system according to the first aspect of the present invention, wherein the control unit is operable to orthogonalize the beam pattern of the base station multi-beam antenna based on a plurality of transfer function values determining a radio-wave-propagation characteristic between the plurality of base station antenna elements and the plurality of terminal antenna elements.

With this structure, even when there are few propagation paths between the base station and one of the terminals, utilizing propagation paths between the base station and the other of the terminals that are separated from each other, multiplicity can increase, thereby improving the frequency utilization efficiency.

A third aspect of the present invention provides a wireless communication system according to the first aspect of the present invention, wherein a number of the base station antenna elements is greater than a maximum number of the terminal antenna elements among the plurality of terminals.

With this structure, burdens of the terminals are reducible, and the propagation paths formed between the base station and the terminals can effectively increase utilizing the relationship that the terminals communicate via the base station.

A fourth aspect of the present invention provides a wireless communication system according to the second aspect of the present invention, wherein each of the plurality of terminals is operable to transmit, to the base station, pilot signals to be used for estimation of a radio-wave-propagation characteristic between each of the plurality of terminals and the base station, wherein the base station is operable to receive the pilot signals, and wherein the control unit is operable to calculate the plurality of transfer function values based on the pilot signals.

With this structure, the base station can perform centralized control for the pilot signals, and efficiency of system operation can be improved.

A fifth aspect of the present invention provides a wireless communication system according to the second aspect of the present invention, wherein the control unit is operable to calculate eigenvectors of a channel matrix whose matrix elements are composed of the plurality of transfer function values, and wherein the control unit is operable to control a set of weight to be imposed on the plurality of base station antenna elements using the eigenvectors of the channel matrix.

With this structure, the radio-wave-propagation characteristics can be precisely evaluated, using the eigenvectors.

A sixth aspect of the present invention provides a wireless communication system according to the second aspect of the present invention, wherein the control unit is operable to calculate a plurality of diagonal elements of a channel matrix whose matrix elements are composed of the plurality of transfer function values, and wherein the control unit is operable to control a set of weight to be imposed on the plurality of base station antenna elements using the plurality of diagonal elements of the channel matrix.

With this structure, the radio-wave-propagation characteristics can be precisely evaluated using the diagonal elements.

A seventh aspect of the present invention provides a wireless communication system according to the second aspect of the present invention, wherein, when one of the plurality of terminals has moved, the one of the plurality of terminals is operable to transmit, to the base station, movement pilot signals to be used for estimating a radio-wave-propagation characteristic between the one of the plurality of terminals and the base station, the base station is operable to receive the movement pilot signals, the control unit is operable to re-calculate a plurality of transfer function values concerning the one of the plurality of terminals, and the control unit is operable to orthogonalize the beam pattern of the base station multi-beam antenna based on the plurality of re-calculated transfer function values.

With this structure, the space division wireless point-to-multipoint communications can be performed even when one or more of the terminals have moved.

An eighth aspect of the present invention provides a wireless communication system according to the seventh aspect of the present invention, wherein the control unit is operable to re-calculate a plurality of transfer function values concerning one or more un-moved terminals, the one or more un-moved terminals belonging to the plurality of terminals.

With this structure, the wireless communications can be performed always utilizing precise transfer function values.

A ninth aspect of the present invention provides a wireless communication system according to the seventh aspect of the present invention, wherein the control unit is not operable to re-calculate a plurality of transfer function values concerning one or more un-moved terminals, the one or more un-moved terminals belonging to the plurality of terminals.

With this structure, since calculation of the transfer values regarding one or more of the terminals can be omitted, the space division wireless point-to-multipoint communications can be rapidly performed even when one or more of the terminals have moved.

A tenth aspect of the present invention provides a wireless communication system according to the seventh aspect of the present invention, wherein the control unit, utilizing mobility as a parameter indicating degree that one of the plurality of terminals has moved in space per unit time, is operable to determine priority of orthogonalization of the base station multi-beam antenna.

With this structure, since the mobility is used, the space division wireless point-to-multipoint communications can be performed, paying respect to priority of communications.

An eleventh aspect of the present invention provides a wireless communication system according to the tenth aspect of the present invention, wherein the control unit is operable to determine the priority of orthogonalization of the base station multi-beam antenna such that priority of one of the plurality of terminals having certain mobility is higher than priority of another of the plurality of terminals having mobility greater than the certain mobility.

With this structure, the space division wireless point-to-multipoint communications can be performed giving high priority to one or more of the terminals that are hard to move.

A twelfth aspect of the present invention provides a wireless communication system according to the tenth aspect of the present invention, wherein the mobility of the plurality of terminals is expressed in terms of respective identifiers given to the plurality of terminals, the plurality of terminals are operable to transmit to the base station the respective identifiers, the control unit is operable to receive the respective identifiers transmitted from the plurality of terminals, and the control unit is operable to determine the priority of orthogonalization of the base station multi-beam antenna based on the respective identifiers received by the base station.

With this structure, since the identifiers are used, the space division wireless point-to-multipoint communications can be performed, paying respect to priority of communications without complicated calculation.

A thirteenth aspect of the present invention provides a wireless communication system according to the first aspect of the present invention, wherein the control unit is provided within the base station.

With this structure, since additional elements except the base station and the terminals need not be provided, the wireless communication system can be simply configured.

According to the present invention, even when there are few propagation paths between the base station and one of the terminals, utilizing propagation paths between the base station and the other of the terminals, each being separated from each other, space multiplicity can increase, thereby improving the frequency utilization efficiency.

According to the present invention, even when the terminals are separated from each other and/or one or more pairs of the terminals cannot directly communicate without via the base station, the base station can detect a channel matrix H of the whole wireless communication system. Therefore, the beam pattern of the base station multi-beam antenna can be easily orthogonalized.

According to the present invention, since exchanging received signals can be omitted, it is not necessary to provide circuits for exchanging the received signals in any of the terminals, thereby reducing circuit scales of the terminals.

The above, and other objects, features and advantages of the present invention will become apparent from the following description read in conjunction with the accompanying drawings, in which like reference numerals designate the same elements.

### BRIEF DESCRIPTION OF DRAWINGS

FIG. 1 is a schematic diagram illustrating a wireless communication system in an embodiment 1 of the present invention;

FIG. 2 is an instantiation figure showing an antenna beam pattern in the embodiment 1 of the present invention;

FIG. 3 is a mimetic diagram illustrating a transmission characteristic in the embodiment 1 of the present invention;

FIG. 4 is an explanatory drawing (a general inverse-matrix) of orthogonalizing processes in the embodiment 1 of the present invention;

FIG. 5 is an explanatory drawing (eigenvalues) of orthogonalizing processes in the embodiment 1 of the present invention;

FIG. 6 is a block diagram illustrating a base station in the embodiment 1 of the present invention;

FIG. 7 is a block diagram illustrating a terminal in the embodiment 1 of the present invention;

FIG. 8 is a block diagram illustrating an antenna transmission-controlling unit (the base station) in the embodiment 1 of the present invention;

FIG. 9 is a block diagram illustrating an antenna reception-controlling unit (the terminal) in the embodiment 1 of the present invention;

FIG. 10 is an explanatory drawing of pilot signal transmission in the embodiment 1 of the present invention;

FIG. 11 is a sequence chart in the embodiment 1 of the present invention;

FIG. 12 is an explanatory drawing of antenna element restriction in the embodiment 1 of the present invention;

FIG. 13 is an explanatory drawing of the quasi-orthogonalizing processes in the embodiment 1 of the present invention;

FIG. 14 is an explanatory drawing of a spread angle θ seen from the base station in the embodiment 1 of the present invention;

FIG. 15 is an explanatory drawing of beam pattern exclusion in the embodiment 1 of the present invention;

FIG. 16 is an explanatory drawing of beam pattern exclusion in the embodiment 1 of the present invention; and

FIG. 17(a) and FIG. 17(b) are explanatory drawings of conventional null-steering.

### BEST MODE FOR CARRYING OUT THE INVENTION

Hereinafter, a description is given of embodiments of the invention with reference to the accompanying drawings.

### Embodiment 1

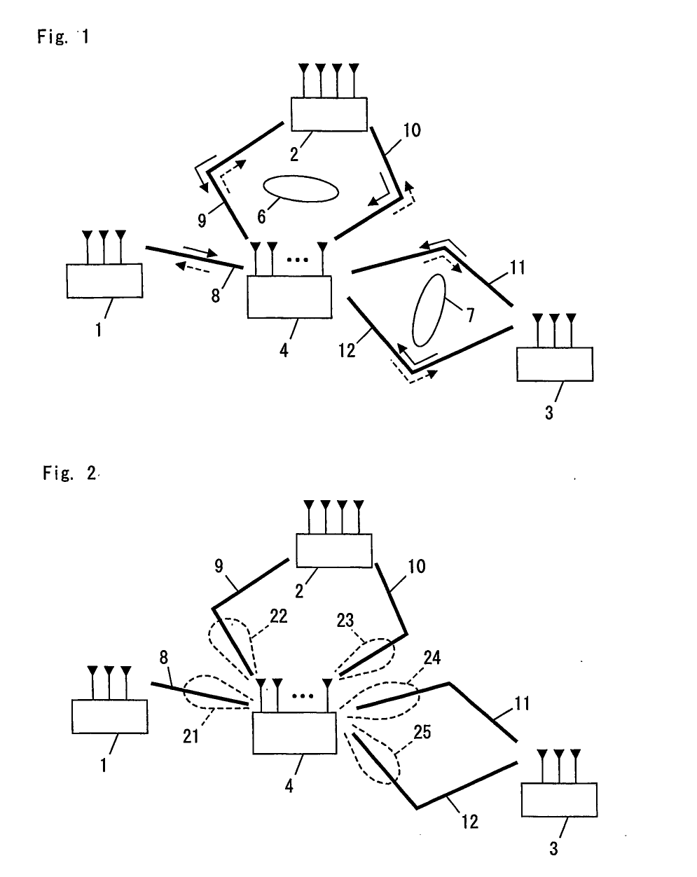

FIG. 1 is a schematic diagram illustrating a wireless communication system in an embodiment 1 of the present invention. As shown in FIG. 1, the wireless communication system of this embodiment comprises a first terminal 1, a second terminal 2, a third terminal 3, and a base station 4. Outline of the wireless communication system will now be explained in advance of detailed explanation of the base station 4 and each of the terminals 1, 2 and 3.

In an example of FIG. 1, an electromagnetic-interference object 6 exists between the base station 4 and the second terminal 2, and an electromagnetic-interference object 7 exists between the base station 4 and the third terminal 3.

Thus, a propagation path 8 is formed between the base station 4 and the first terminal 1. Similarly, a propagation path 9 and a propagation path 10 are formed between the base station 4 and the second terminal 2, and a propagation path 11 and a propagation path 12 are formed between the base station 4 and the third terminal 3, respectively.

FIG. 2 illustrates an antenna beam pattern formed in the base station 4 in a condition of FIG. 1. In FIG. 2, a main beam 21 is formed for the propagation path 8, a main beam 22 is formed for the propagation path 9, a main beam 23 is formed for the propagation path 10, a main beam 24 is formed for the propagation path 11, and a main beam 25 is formed for the propagation path 12, respectively.

As mentioned in full detail later, each of the base station 4 and the terminals 1, 2 and 3 comprises a multi-beam antenna that simultaneously forms of a plurality of beam pattern to perform space division multiplex communications using the same frequency.

As shown in FIG. 2, the base station 4 forms five orthogonal beams, that is, a beam for the propagation path 8 toward the first terminal 1, two beams for the propagation paths 9 and 10 toward the second terminal 2, and two beams for the propagation paths 11 and 12 toward the third terminal 3, thereby performing the space division multiplex communications.

In this example, considering (point-to-point) space between the base station 4 and one of the terminals 1, 2 and 3, two propagation paths exist at most and space division wireless communications with only two channels can be realized, but space division wireless communications for three or more channels cannot be realized.

However, according to the present invention, utilizing the five propagation paths 8 to 12 between the base station 4 and the three terminals 1, 2 and 3, space division wireless point-to-multipoint communications with five channels can be realized. Therefore, frequency utilization efficiency in space with unit volume is remarkably improvable.

In this embodiment, since the base station 4, as a center, performs space division multiplex communications with the terminals 1, 2 and 3, flexibility of null-steering at the base station 4 should be made high.

In other words, the number of null points that can be formed in a multi-beam antenna of the base station 4 should be many enough, and the number of antenna elements of the base station 4 should be greater than the number of antenna elements for any of the terminals 1, 2 and 3.

Due to this, considering a relationship that the terminals 1, 2 and 3 communicate via the base station 4, the number of the propagation paths can be preferably utilized without waste.

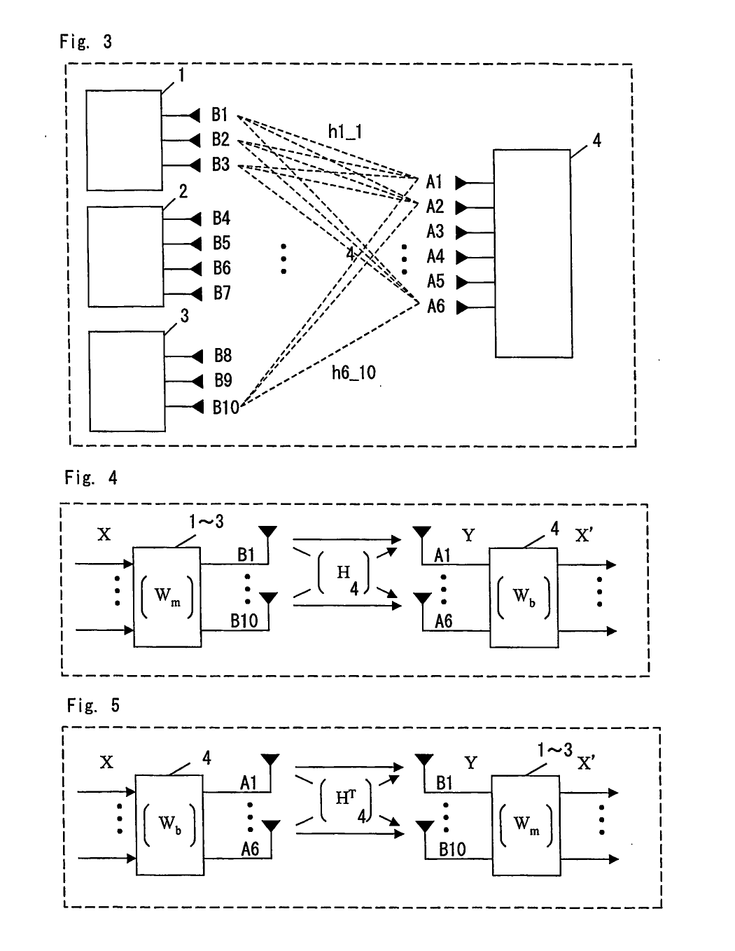

Next, a method for orthogonalizing a beam pattern in the base station 4 is explained. FIG. 3 illustrates transmission characteristics formed between the base station 4 and the terminals 1, 2 and 3 of the wireless communication system of FIG. 1. Each of the transmission characteristics corresponds to every antenna elements of the multi-beam antennas.

In FIG. 3, the base station 4 comprises a multi-beam antenna comprising six antenna elements A1, A2, A3, A4, A5, and A6. The first terminal 1 comprises a multi-beam antenna comprising three antenna elements B1, B2 and B3. The second terminal 2 comprises a multi-beam antenna comprising four antenna elements B4, B5, B6 and B7. The third terminal 3 comprises a multi-beam antenna comprising three antenna elements B8, B9 and B10.

In FIG. 3, assume that a transfer function value between an antenna element Ai of the base station 4 and an antenna element Bj of one of the terminals 1, 2 and 3 is expressed by a value of hi_j, then, a propagation characteristic matrix H can be expressed by the following formula 1. Of course, the number of antenna elements in FIG. 3 is a mere example and can be changed variously.

$$H = ( \begin{matrix}h1\_ 1 , h1\_ 2 , h1\_ 3 , & … & , h1\_ 10 \\ h2\_ 1 , h2\_ 2 , & … & , h2\_ 10 \\ ⋮ & ⋰ & ⋮ \\ h5\_ 1 , h5\_ 2 , & … & , h5\_ 10 \\ h6\_ 1 , h6\_ 2 , & … & , h6\_ 10\end{matrix} ) \qquad [ Formula 1 ]$$

When a bandwidth of signals used for space division multiplex communications is narrow enough in comparison with a frequency characteristic of a transfer function value hi_j, the transfer function value hi_j can be expressed using the following simple formula;
hi_{—}j=Ae^{-jθ}
where A is an amplitude attenuation term through the composed propagation path, and θ is a phase delay term through the composed propagation path.

To form an orthogonal beam, the propagation characteristic matrix H is estimated and the matrix H is diagonalized. Then, radio signals are separated spatially and interference waves are canceled.

As taught by linear algebra, processes using a general inverse-matrix and processes using eigenvalues and/or eigenvectors can be used to orthogonalize the matrix H.

Referring to FIG. 4, an example of processes using the general inverse-matrix is explained. In FIG. 4, assume that a vector “X” is a transmitted signal vector composed of components inputted into the first terminal 1, components inputted into the second terminal 2 and components inputted into the third terminal 3, a matrix “Wₘ” is a weight matrix to be multiplied to the transmitted signal vector X, and a matrix “H” is a propagation characteristic matrix.

Furthermore, a vector “Y” is a received signal vector composed of components received at the base station 4, a matrix “W_{b}” is a weight matrix to be multiplied to the received signal vector Y, and a vector “X′” is a transmitted signal vector estimated by the base station 4.

Then, formulas for diagonalization are the following formulas 2, 3 and 4. Herein, a vector “I” in the formula 3 is a unit matrix, and a superscript symbol “−1” in the formula 4 means a general inverse-matrix.
X′=W_{b}HWₘX [Formula 2]
Wₘ=I [Formula 3]
W_{b}=H⁻¹ [Formula 4]

Referring to FIG. 5, an example of processes using eigenvalues and/or eigenvectors is explained. In FIG. 5, assume that a vector “X” is a transmitted signal vector composed of components inputted into the base station 4, a matrix “W_{b}” is a weight matrix to be multiplied to the transmitted signal vector X, and a matrix “H^{T}” is a propagation characteristic matrix.

Furthermore, a vector “Y” is a received signal vector composed of components inputted into the first terminal 1, components inputted into the second terminal 2 and components inputted into the third terminal 3, a matrix “Wₘ” is a weight matrix to be multiplied to the received signal vector Y, and a vector of “X′” is a transmitted signal vector estimated by the base station 4.

Then, formulas for diagonalization are the following formulas 5, 6 and 7. Herein, a superscript symbol “T” in the formula 5 means a transpose of a matrix, a superscript symbol of “*” in the formula 6 means a conjugate transpose. A matrix “P” is a matrix in which eigenvectors corresponding to eigenvalues of a matrix (H^{T})*H^{T} are normally orthogonalized.
X′=WₘH^{T}W_{b}X [Formula 5]
Wₘ=P⁻¹(H^{T})* [Formula 6]
W_{b}=P [Formula 7]

Next, details of the base station 4 and the terminals 1, 2 and 3 are concretely explained. For simplification of explanation, assume that a propagation characteristic matrix H has been already estimated.

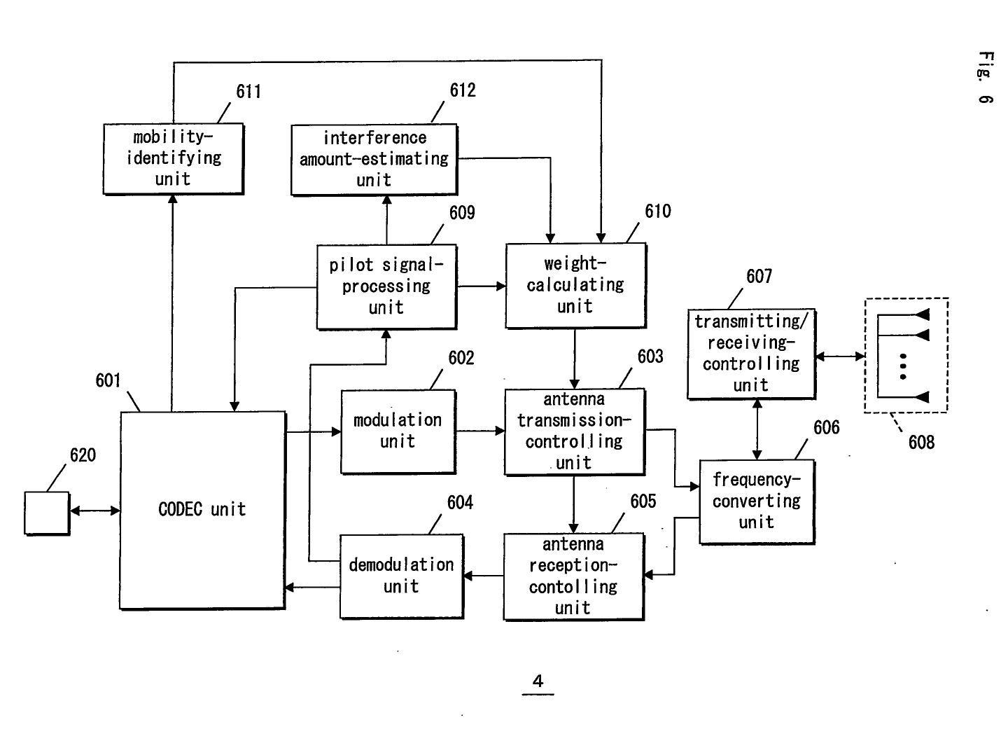

FIG. 6 is a block diagram illustrating the base station 4. As shown in FIG. 6, the base station 4 comprises the following elements.

When a CODEC unit 601 inputs signals via an input-output port 620, the CODEC unit 601 encodes the signal and outputs a result thereof to a modulation unit 602.

When the CODEC unit 601 inputs a demodulation result from a demodulation unit 604, the CODEC unit 601 decodes the demodulation result and output a decoded result to the input-output port 620.

The CODEC unit 601 also inputs a processing result from a pilot signal-processing unit 609, and outputs the processing result to a mobility-identifying unit 611.

When a modulation unit 602 inputs signals from the CODEC unit 601, the modulation unit 602 modulates the signals according to a determined modulation manner, and outputs a modulated result to an antenna transmission-controlling unit 603. As mentioned later, when the antenna transmission-controlling unit 603 inputs the modulated result, the antenna transmission-controlling unit 603 determines a beam pattern for antenna elements of a multi-beam antenna 608, and outputs a determined beam pattern to an antenna reception-controlling unit 605.

The antenna transmission-controlling unit 603 generates sending signals according to the determined beam pattern, and outputs the sending signals to a frequency-converting unit 606.

The demodulation unit 604 demodulates signals received from the antenna reception-controlling unit 605, and outputs a result thereof to the CODEC unit 601 and the pilot signal-processing unit 609.

When the antenna reception-controlling unit 605 inputs signals from the frequency-converting unit 606, the antenna reception-controlling unit 605 processes the signals according to the beam pattern determined by the antenna transmission-controlling unit 603, and outputs a result thereof to the demodulation unit 604.

A transmitting/receiving-controlling unit 607 selects one of a transmitting state and a receiving state. In the transmitting state, the transmitting/receiving-controlling unit 607 outputs signals inputted from the frequency-converting unit 606 to the multi-beam antenna 608. And, in the receiving state, the transmitting/receiving-controlling unit 607 outputs signals received by the multi-beam antenna 608 to the frequency-converting unit 606.

The frequency-converting unit 606 is controlled by transmitting/receiving-controlling unit 607. In the transmitting state, the frequency-converting unit 606 converts frequency of signals inputted from the control unit 603, and output a result thereof to the transmitting/receiving-controlling unit 607. In the receiving state, the frequency-converting unit 606 converts frequency of signals inputted from the control unit 607, and outputs a result thereof to the antenna reception-controlling unit 605.

When the pilot signal-processing unit 609 inputs pilot signals, which are transmitted from any of antenna elements of the terminals 1, 2 and 3, from the demodulation unit 604, the pilot signal-processing unit 609 detects a drift amount of the pilot signals in phase and/or amplitude, and outputs a result thereof to an interference amount-estimating unit 612 and a weight-calculating unit 610.

The interference amount-estimating unit 612 estimates interference amounts of pairs, each of the pairs being selected from a group consisting of propagation paths 8 to 12 toward the terminals 1, 2 and 3.

The weight-calculating unit 610 calculates weight of each antenna element of the multi-beam antenna 608 in accordance with the interference amounts estimated by the interference amount-estimating unit 612.

The antenna transmission-controlling unit 603 determines a beam pattern of the multi-beam antenna 608 according to the weight calculated by the weight-calculating unit 610. A unique identifier has been given to each of the terminals 1, 2 and 3. The mobility-identifying unit 611 identifies the identifier.

In this embodiment, the weight-calculating unit 610 and the antenna transmission-controlling unit 603 correspond to a control unit. The control unit orthogonalizes a beam pattern of the base station multi-beam antenna 608, and is provided within the base station 4.

Next, the terminals 1, 2 and 3 are explained. Since each of the terminals 1, 2 and 3 has the same structure, only the terminal 1 is explained.

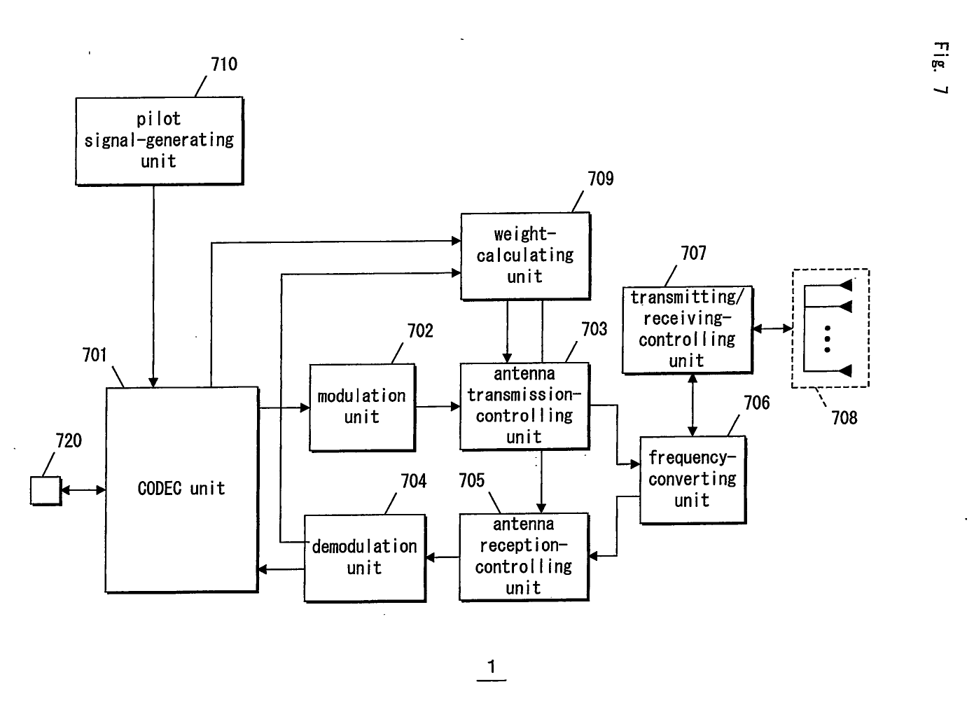

FIG. 7 is a block diagram illustrating the first terminal 1. As shown in FIG. 7, the terminal 1 comprises: a CODEC unit 701; a modulation unit 702; an antenna transmission-controlling unit 703; a demodulation unit 704; an antenna reception-controlling unit 705; a frequency-converting unit 706; a transmitting/receiving-controlling unit 707; a multi-beam antenna 708 having L antenna elements; a weight-calculating unit 709; a pilot signal-generating unit 710; and an input-output port 720.

In FIG. 7, to avoid duplicated explanation, the same name is given to an element having the same function as that of FIG. 6. In FIG. 7, the pilot signal-generating unit 701 generates pilot signals to be sent to the base station 4 for estimation of a radio-wave-propagation characteristic. The multi-beam antenna 708 transmits pilot signals generated by the pilot signal-generating unit 710 to the base station 4.

After the base station 4 has orthogonalized a beam pattern thereof, the antenna transmission-controlling unit 703 and the antenna reception-controlling unit 705 cancels interference waves utilizing at least one of the zero forcing method and the maximum likelihood estimation method.

Hereinafter, using an example that the base station 4 and the second terminal 2 in FIG. 1 communicate with each other, a wireless-communications method in this embodiment will now be explained in detail.

Assume that a value of “M” indicates space multiplicity of the whole system, a value of “N” is the number of antenna elements of the multi-beam antenna 608 of the base station 4, a value of “L” is the number of antenna elements of the multi-beam antennas 708 of the concerned terminal (in this example, terminal 2), and a value of “K” indicates multiplicity toward the concerned terminal (in this example, terminal 2). That is, M=5, N=6, L=4, and K=2 in this example. Of course, these values relate to a mere example, and can be changed variously.

The CODEC unit 601 of the base station 4 makes M frames containing data to be transmitted to at least one of the terminals 1, 2 and 3, and outputs each of the M frames to the modulation unit 602 with time synchronism. The modulation unit 602 multi-carrier-modulates each of the frames.

As described above, when a sub-carrier bandwidth is narrow enough in comparison with a frequency characteristic of a transfer function value hi_j, the transfer function value hi_j can be expressed using the following simple formula.
hi_{—}j=Ae^{-jθ}

Furthermore, since sub-carrier signals are orthogonalized, communications independent for every frequency can be performed.

Hereinafter, for simplification of explanation, how a group of M sub-carrier signals of the same frequency is handled is explained.

The modulation unit 602 enlarges M sub-carrier modulated signals (X1, X2, . . . , XM) into N transmitted signal vectors X (X1, X2, . . . , XM, . . . ,XN) (e.g. using zero-inserting), and outputs the N transmitted signal vectors X to the antenna transmission-controlling unit 603.

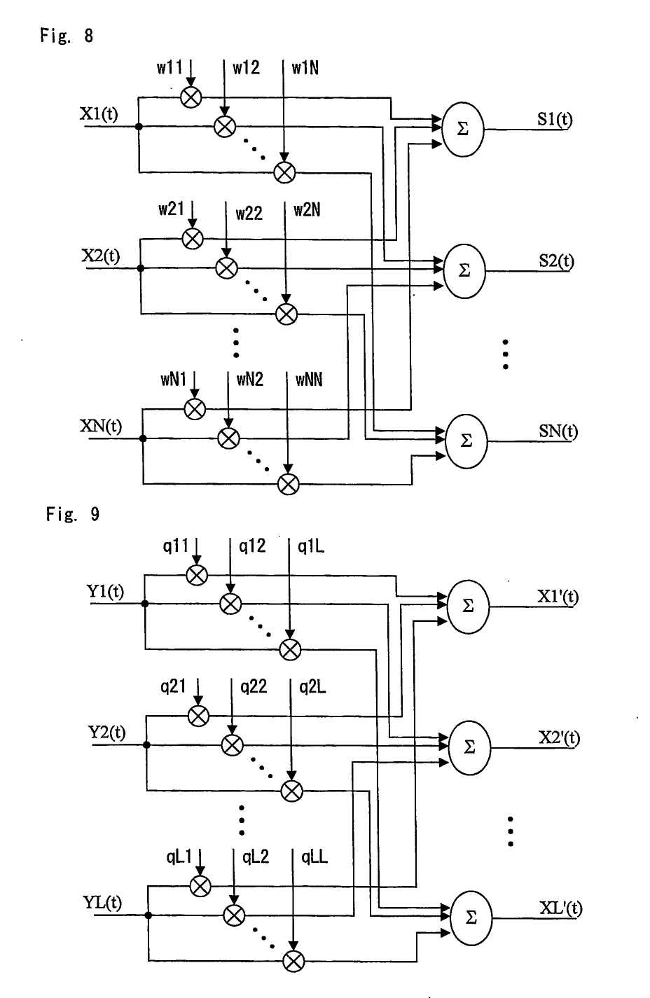

Next, referring to FIG. 8, details of the antenna transmission-controlling unit 602 are explained. According to the formula 4 or the formula 7, the weight-calculating unit 610 calculates the weight matrix W_{b} considering one or more parameters obtained from the interference amount-estimating unit 612, the pilot signal-processing unit 609, and the mobility-identifying unit 611.

The antenna transmission-controlling unit 602 multiplies the weight matrix W_{b} (w11, w12, . . . , w1N, . . . , wN1, wN2, . . . , wNN) to the transmitted signal vectors X to generate transmitting beam vectors S (S1, S2, . . . , SM, . . . , SN). The matrix multiplication is performed by digital signal processes in a baseband frequency.

The frequency-converting unit 606 up-converts the transmitting beam vectors S into a high frequency band to generate up-converted transmitting beam vectors, and the multi-beam antenna 608 sends the up-converted transmitting beam vectors as space division multiplex signals to the terminals 1, 2 and 3 after the transmitting/receiving-controlling unit 607 has secured time synchronism.

The multi-beam antenna 708 of the terminal 2 receives the space division multiplex signals that have come from the base station 4 via one or more propagation paths toward the terminal 2.

The transmitting/receiving-controlling unit 707 obtains the received space division multiplex signals with time synchronism, and the frequency-converting unit 706 down-converts the received space division multiplex signals into the baseband frequency to generate received signal vectors Y (Y1, Y2, . . . , YL), and the received signal vectors Y is outputted to the antenna reception-controlling unit 705.

Next, referring to FIG. 9, details of the antenna reception-controlling unit 705 are explained. The weight-calculating unit 709 calculates, using the formula 3 or the formula 6, the weight matrix Wm considering parameters obtained from the CODEC unit 701 and the demodulation unit 704.

The antenna reception-controlling unit 705 multiplies the weight matrix Wₘ (q11, q12, . . . , q1L, qL2, . . . , qLL) to the received signal vectors Y to generate estimated transmitted vectors X′ (X′1, X′2, . . . , X′L).

The antenna reception-controlling unit 705 reduces the estimated transmitted vectors X′ into K element vectors that include interference-canceled sub-carrier signals to output a result thereof to the demodulation unit 704. The demodulation unit 704 performs multi-carrier demodulation composing all sub-carriers to the result, and generates K received frames.

Processes from the base station 4 to the second terminal 2 have been above explained. Explanation of processes from the second terminal 2 to the base station 4 is omitted, because they are almost same as mentioned above.

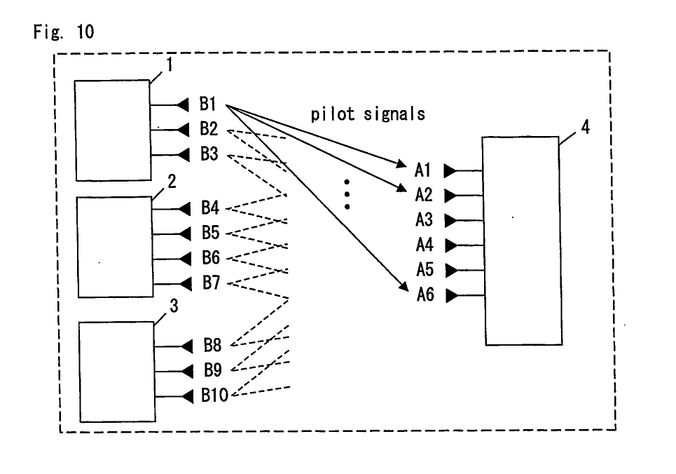

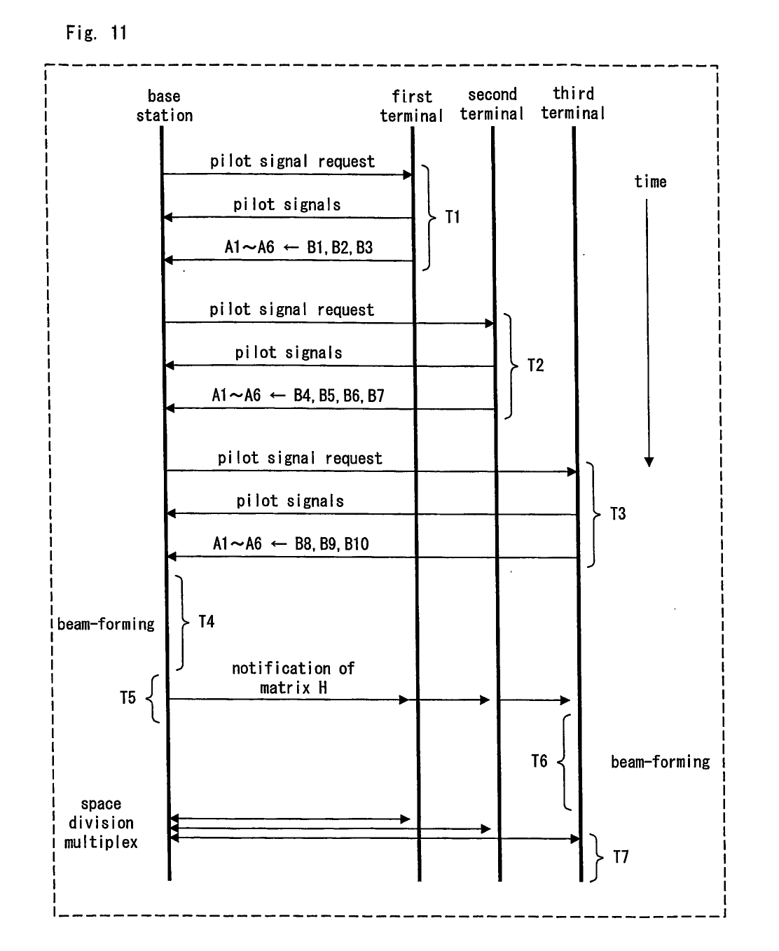

Next, a method for estimating a propagation characteristic matrix H will now be explained. As shown in FIG. 10, the antenna element Bj (j=1, 2, . . . , 10) of the terminals 1, 2 and 3 sequentially and respectively sends to each of the antenna elements A1, A2, . . . , A6 of the base station 4 pilot signals for estimating the transfer function values (h1_j, h2_j, h3_j, h4_j, h5_j, h6_j). Thereby, the pilot signal-processing unit 609 of the base station 4 can collectively calculate the propagation characteristic matrix H.

The pilot signals may be non-modulated signals, pseudo-random signals (e.g. pseudo-noise codes), and so on. The pilot signal-generating units 710 of the terminals 1, 2 and 3 may transmit to the base station 4 the pilot signals when the terminals 1, 2 and 3 have moved to change their propagation path characteristics.

Next, referring to FIG. 11, processes from a pilot signal request of the base station 4 to the establishment of space division multiplex communications at the whole system will now be explained. In a period T1, the base station 4, transmits the pilot signal request to the first terminal 1, and pilot signals are transmitted sequentially from the antenna elements B1-B3 of the first terminal 1.

In a period T2, the base station 4 transmits the pilot signal request to the second terminal 2, and pilot signals are transmitted sequentially from the antenna elements B4-B7 of the second terminal 2.

In a period T3, the base station 4 transmits the pilot signal request to the third terminal 3, and pilot signals are transmitted sequentially from the antenna elements B8-B10 of the third terminal 3.

In a period T4, the base station 4 estimates the propagation characteristic matrix H, and performs beam-forming for an orthogonal beam. In a period T5, the base station 4 notifies the estimated propagation characteristic matrix H to the terminals 1, 2 and 3.

In a period T6, each of the terminals 1, 2 and 3 performs beam-forming for an orthogonal beam. In a period T7, space division multiplex communications are performed.

In this embodiment, since the base station 4, as a center, performs space division multiplex point-to-multipoint communications with the terminals 1, 2 and 3, pilot signals are transmitted not from the base station 4 to the terminals 1, 2 and 3 but from the terminals 1, 2 and 3 to the base station 4. Thereby, the propagation characteristic matrix H can be easily estimated.

Assume that a value of “N” is the number of antenna elements of the base station 4, and a value of “M” is a number of propagation paths utilized for space division multiplex communications. Herein, in some cases where M>N, there is a possibility that a degree of separation of the propagation paths may fall, and precision of null-steering may be deteriorated.

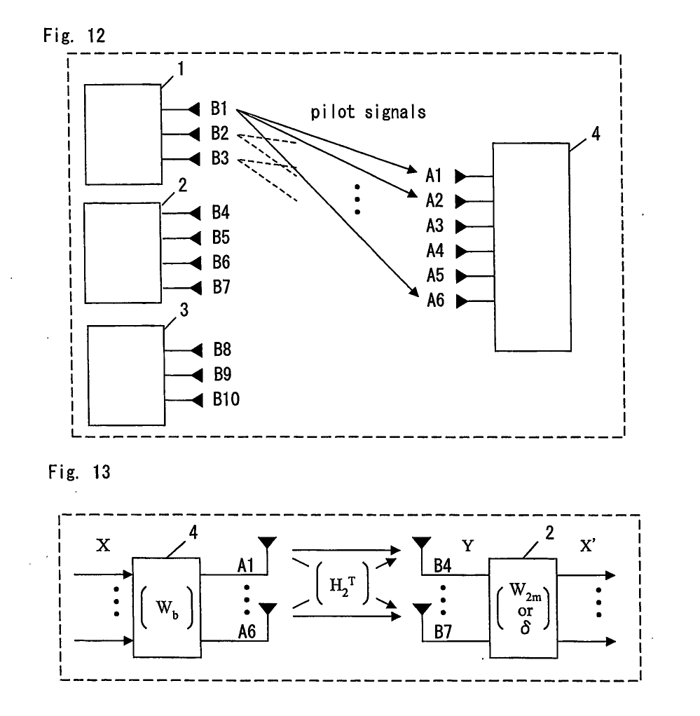

Therefore, as shown in FIG. 12, it is preferable to restrict a number of pilot signals received by the base station 4 to form beams utilizing a matrix H that satisfies a condition that M<N. Thereby, the precision of null-steering can be kept fine.

To be more specific, it is preferable to insert zeros into a part of transfer function values of the matrix H to reduce a rank M of the matrix H, thereby restricting the number of the pilot signals. The pilot signals may be determined based on channel priority assigned to the terminals 1, 2 and 3.

$$H = ( \begin{matrix}h1\_ 1 , h1\_ 2 , h1\_ 3 , & … & , h1\_ 10 \\ h2\_ 1 , h2\_ 2 , & … & , h2\_ 10 \\ h3\_ 1 , h3\_ 2 , & … & , h3\_ 10 \\ 0 , 0 & … & , 0 \\ 0 , 0 & … & , 0 \\ 0 , 0 & … & , 0 \end{matrix} ) \qquad [ Forlmula 8 ]$$

Next, a method for quasi-orthogonalizing a beam pattern in the terminals 1, 2 and 3 will now be explained. In this embodiment, as shown in FIG. 1, communications can be performed even when the terminals 1, 2 and 3 are spatially separated from each other and the terminals 1, 2 and 3 cannot communicate with each other without relays by the base station 4.

In other words, in the case, one of the terminals 1, 2 and 3 cannot share one or more multi-beam antennas of the other of the terminals 1, 2 and 3.

Therefore, as shown in FIG. 5, when the base station 4 and the terminals 1, 2 and 3 perform space division multiplex communications, any of the terminals 1, 2 and 3 cannot detect all of the received signal vectors Y, and strict orthogonality may not be formed.

In this embodiment, a beam pattern is quasi-orthogonalized utilizing at least one of the zero forcing method and the maximum likelihood estimation method. “Quasi-orthogonalization” means that propagation paths are limited to paths having high path gain, but the number of the paths is within a number of formable null points. Thereby, the space division multiplex communications system substantially holds orthogonality, although strict and mathematical orthogonality is lost.

The quasi-orthogonalization is effective by the following reason.

(1) It is enough that any of the terminals 1, 2 and 3 has a small number of propagation paths toward the base station 4, that is, K<M.

(2) If a spread angle θ of any of the terminals 1, 2 and 3 is large enough, the angle θ being formed by a pair of propagation paths toward itself, interference between the pair of propagation paths can be lessened even by an antenna with a small number of elements.

A quasi-orthogonalizing method will now be concretely explained taking a case where space division multiplex communications between the base station 4 and the second terminal 2 of FIG. 1 are performed.

Assume that the base station 4 has already determined the weight matrix W_{b} utilizing the general inverse-matrix or the eigenvalue/eigenvector method, and the beam pattern also has already been orthogonalized.

Referring to FIG. 13, processes that the second terminal 2 utilizes the zero forcing method or the maximum likelihood estimation method are explained. In FIG. 13, assume that a vector of “X” is a transmitted signal vector composed of components inputted into the base station 4, a matrix of “W_{b}” is a weight matrix to be multiplied to the transmitted signal vector X, and a matrix of “H₂^{T}” is a propagation characteristic matrix between the base station 4 and the second terminal 2.

Furthermore, a vector of “Y” is a received signal vector received by the second terminal 2, a matrix of “W₂ₘ” is a weight matrix to be multiplied to the received signal vector Y, a value of “δ” is an error norm in accordance with the received signal vector Y, and a vector of “X” is a transmitted signal vector estimated by the base station 4.

Herein, the propagation characteristic matrix H₂ is expressed by the formula 9. The propagation characteristic matrix H₂ is a partial matrix of the matrix H of the formula 1, the second terminal 2 can obtain information of the propagation characteristic matrix H₂ according to notification from the base station 4.

$${H}_{2} = ( \begin{matrix}h1\_ 4 , & h1\_ 5 , & h1\_ 6 , & h1\_ 7 \\ h2\_ 4 , & h2\_ 5 , & h2\_ 6 , & h2\_ 7 \\ h3\_ 4 , & h3\_ 5 , & h3\_ 6 , & h3\_ 7 \\ h4\_ 4 , & h4\_ 5 , & h4\_ 6 , & h4\_ 7 \\ h5\_ 4 , & h5\_ 5 , & h5\_ 6 , & h5\_ 7 \\ h6\_ 4 , & h6\_ 5 , & h6\_ 6 , & h6\_ 7\end{matrix} ) \qquad [ Formula 9 ]$$

When the zero forcing method is used, the formula 10 is a formula that the second terminal 2 diagonalizes the partial matrix H₂. Furthermore, the second terminal 2 can estimate a transmitted signal vector X′ utilizing the weight matrix W₂ₘ expressed by the formula 11.
X′=W₂ₘH₂^{T}W_{b}X [Formula 10]
W₂ₘ=(H₂^{T}W_{b})⁻¹ [Formula 11]

When the maximum likelihood estimation method is used, the second terminal 2 can estimate the transmitted signal vector X′ by calculating as a round robin all the cases where the transmitted signal vector X′ can take to find a case where the error norm δ is minimum. In the formula 12, the symbol of “81 -∥” means a norm.
δ=∥Y-H₂^{l W}_{b}X′∥[Formula 12]

The terminals 1 and 3 can quasi-orthogonalize beam patterns similarly.

Next, a space division multiplex when the base station 4 has imperfectly orthogonalized a beam pattern is explained.

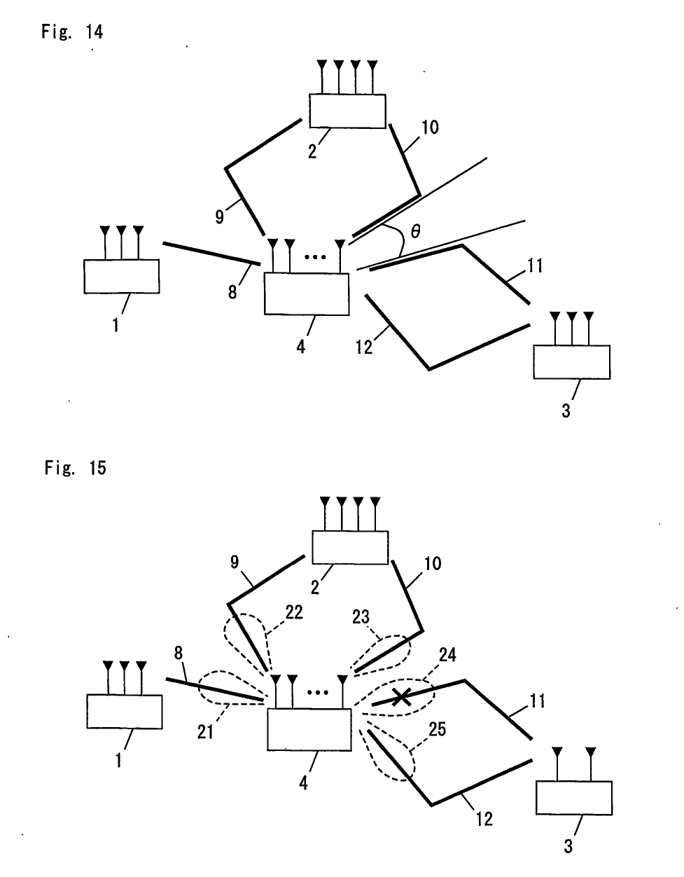

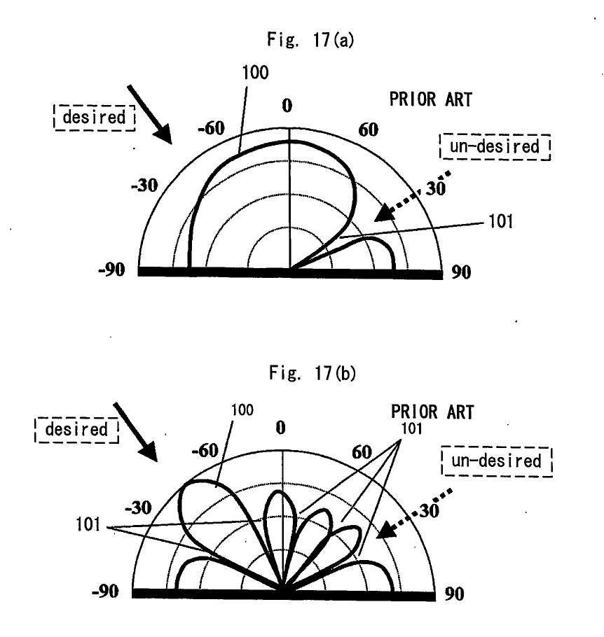

As shown in FIG. 14, this situation may happen when a spread angle θ between adjacent propagation paths seen from the base station 4 is small. For example, the six-element array antenna in FIG. 17(b) has a beam pattern comprising a central point of the main beam 100, and two null points 101 adjacent thereto. An angle formed by the central point and one of the two null points 101 is about 15 degrees.

It means that, when two propagation paths form an angle less than 15 degrees, mutual interference cannot be avoided unless the number of antenna elements increases. In this case, although one or more of the terminals 1, 2 and 3 have orthogonalized beam patterns according to the formulas 10, 11 and 12, transmission errors may occur caused by the interference.

In this embodiment, since the base station 4 has known the propagation characteristic matrix H, an interference amount-estimating unit 612 can estimate an interference amount that an orthogonal beam of the base station 4 affects a received signal vector Y of a specific terminal of the terminals 1, 2 and 3. When a beam pattern interfering with a level greater than a determined value is detected, the beam pattern is excluded from the space division multiplex.

When the transmission characteristic changes gently enough, the interference amount-estimating unit 612 can estimate the interference amount utilizing the formula 13.
Y=HWₘX [Formula 13]

Referring to FIG. 15, an example of employing this estimation is explained. As shown in FIG. 15, when the base station 4 has estimated an interference amount of the second terminal 2 and an interference amount of a pair of main beams 23 and 24 exceeds the determined value, the base station 4 excludes the main beam 24 from the bunch of main beams used for the space division multiplex.

According to this excluding method, although some space multiplicity is sacrificed, interference between propagation paths can be effectively lessened to reduce transmission errors, thereby improving reliability of communications.

When this excluding method is applied to a plurality of terminals, a total amount M of the propagation paths increases, and pairs of propagation paths interfering with each other also increase.

Then, the following processes preferably are performed: first, calculating total interference amounts of the terminals 1, 2 and 3 for every beam pattern; and secondly, sequentially excluding a beam pattern with the greatest total interference amount unless interference is less than the determined value. Due to the processes, the maximum space multiplicity can be obtained as a whole, although processes thereof are complicated.

To prevent interference with easier processes, it is also effective to select propagation paths such that all of spread angles θ have values large enough.

Since beam patterns to be excluded is randomly selected depending on transmission characteristics, when QoS (Quality of Service) is necessary, beam patterns can be selected according to priority of the terminals 1, 2 and 3.

Next, a method for assigning priority to the terminals 1, 2 and 3 is explained. When space division multiplex communications are performed, it can be assumed that the base station 4 is in a not-moving state in general. However, any of the terminals 1, 2 and 3 may be in the not-moving state or in a moving state.

When a terminal in the moving status exists, the base station 4 must estimate the propagation characteristic matrix H following a moving speed of the terminal in the moving status. When the spread angle θ changes, whole null-steering cannot be performed in some cases.

In this embodiment, therefore, priority is assigned utilizing a parameter of mobility indicating a degree that a corresponding terminal of the terminals 1, 2 and 3 has moved, thereby forming effectively an orthogonal beam of the base station 4.

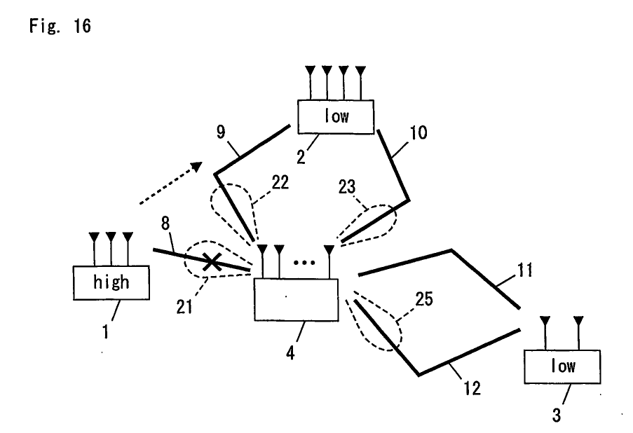

For example, as shown in FIG. 16, in a case where the first terminal 1 is in the moving status, the second and third terminals 2 and 3 are in the not-moving state, the base station 4 detects the states of the terminals 1, 2 and 3 from time-based changing information of transfer function values. The transfer function values are elements of the propagation characteristic matrix H. Then, the base station 4 assigns high mobility to the first terminal 1, and assigns low mobility to the second terminal 2 and the third terminal 3.

Setting the priority may differ for every application. For example, when data should be transmitted in almost real time at a high speed such that only a transmission delay time within few seconds is permitted, it is preferable to assign higher priority to a terminal with low mobility.

Thereby, a dynamic disturbance factor against the orthogonal beam decreases and high priority is assigned to beams hard to move. As a result, space multiplicity of the whole system can be stably assured preventing an outage in real time communications. In FIG. 16, when interference occurs, the main beam 21 toward the first terminal 1 is excluded from the space division multiplex.

It is preferable to give a mobility identifier (e.g. a mere integer value) to any of the terminals 1, 2 and 3. Then, the base station 4 can omit the processes for detecting the states of the terminals 1, 2 and 3, only by referring to the mobility identifier.

Furthermore, the fixed mobility identifier is preferably assigned to any of the terminals 1, 2 and 3 according to considerable usage form thereof, each of CODEC units 701 of the terminals 1, 2 and 3 stores the assigned fixed mobility identifier therein. Each of the terminals 1, 2 and 3 timely sends its mobility identifier to the base station 4, the mobility-identifying unit 611 of the base station 4 identifies the sent mobility identifier, and the base station 4 reflects the identified mobility identifier to priority control.

It is further preferable that, when one of the terminals 1, 2 and 3 has moved, the one transmits, to the base station 4, movement pilot signals used for estimating a radio-wave-propagation characteristic between the one and the base station 4. The base station 4 receives the movement pilot signals and re-calculates transfer function values concerning the one. Then, the base station 4 orthogonalizes the beam pattern of the base station multi-beam antenna based on the re-calculated transfer function values.

Herein, the base station 4 may re-calculate transfer function values concerning one or more un-moved terminals. Otherwise, the base station 4 may not re-calculate the transfer function values concerning the one or more un-moved terminals.

### INDUSTRIAL APPLICABILITY

A wireless communication system of the present invention can be preferably utilized in technical fields of a wireless LAN and a wireless audio video streaming that possess point-to-multipoint network topology, and so on.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A wireless communication system comprising:
a base station; a plurality of terminals; and a control unit,
wherein said base station and each of said plurality of terminals are operable to simultaneously perform space division multiplex wireless transmission of information using a same frequency,
wherein at least one of said plurality of terminals communicates with said base station via a plurality of propagation paths,
wherein said base station comprises a base station multi-beam antenna used for the space division multiplex wireless transmission,
wherein said base station multi-beam antenna comprises a plurality of base station antenna elements,
wherein each of said plurality of terminals comprises a terminal multi-beam antenna used for the space division multiplex wireless transmission,
wherein said terminal multi-beam antenna comprises a plurality of terminal antenna elements, and
wherein said control unit is operable to orthogonalize a beam pattern of said base station multi-beam antenna, thereby controlling the space division multiplex wireless transmission.

2. The wireless communication system as claimed in claim 1, wherein said control unit is operable to orthogonalize the beam pattern of said base station multi-beam antenna based on a plurality of transfer function values determining a radio-wave-propagation characteristic between said plurality of base station antenna elements and said plurality of terminal antenna elements.

3. The wireless communication system as claimed in claim 1, wherein a number of said base station antenna elements is greater than a maximum number of said terminal antenna elements among said plurality of terminals.

4. The wireless communication system as claimed in claim 2, wherein each of said plurality of terminals is operable to transmit, to said base station, pilot signals to be used for estimation of a radio-wave-propagation characteristic between each of said plurality of terminals and said base station,
wherein said base station is operable to receive the pilot signals, and
wherein said control unit is operable to calculate the plurality of transfer function values based on the pilot signals.

5. The wireless communication system as claimed in claim 2, wherein said control unit is operable to calculate eigenvectors of a channel matrix whose matrix elements are composed of the plurality of transfer function values, and
wherein said control unit is operable to control a set of weight to be imposed on said plurality of base station antenna elements using the eigenvectors of the channel matrix.

6. The wireless communication system as claimed in claim 2, wherein said control unit is operable to calculate a plurality of diagonal elements of a channel matrix whose matrix elements are composed of the plurality of transfer function values, and
wherein said control unit is operable to control a set of weight to be imposed on said plurality of base station antenna elements using the plurality of diagonal elements of the channel matrix.

7. The wireless communication system as claimed in claim 2, wherein, when one of said plurality of terminals has moved, the one of said plurality of terminals is operable to transmit, to said base station, movement pilot signals to be used for estimating a radio-wave-propagation characteristic between said one of said plurality of terminals and said base station, said base station is operable to receive the movement pilot signals, said control unit is operable to re-calculate a plurality of transfer function values concerning the one of said plurality of terminals, and said control unit is operable to orthogonalize the beam pattern of said base station multi-beam antenna based on the plurality of re-calculated transfer function values.

8. The wireless communication system as claimed in claim 7, wherein said control unit is operable to re-calculate a plurality of transfer function values concerning one or more un-moved terminals, the one or more un-moved terminals belonging to said plurality of terminals.

9. The wireless communication system as claimed in claim 7, wherein said control unit is not operable to re-calculate a plurality of transfer function values concerning one or more un-moved terminals, the one or more un-moved terminals belonging to said plurality of terminals.

10. The wireless communication system as claimed in claim 7, wherein said control unit, utilizing mobility as a parameter indicating degree that one of said plurality of terminals has moved in space per unit time, is operable to determine priority of orthogonalization of said base station multi-beam antenna.

11. The wireless communication system as claimed in claim 10, wherein said control unit is operable to determine the priority of orthogonalization of said base station multi-beam antenna such that priority of one of said plurality of terminals having certain mobility is higher than priority of another of said plurality of terminals having mobility greater than the certain mobility.

12. The wireless communication system as claimed in claim 10, wherein the mobility of said plurality of terminals is expressed in terms of respective identifiers given to said plurality of terminals, said plurality of terminals are operable to transmit to said base station the respective identifiers, said control unit is operable to receive the respective identifiers transmitted from said plurality of terminals, and said control unit is operable to determine the priority of orthogonalization of said base station multi-beam antenna based on the respective identifiers received by said base station.

13. The wireless communication system as claimed in claim 1, wherein said control unit is provided within said base station.

14. A base station for a wireless communication system comprising said base station and a plurality of terminals, said base station and said plurality of terminals simultaneously performing space division multiplex wireless transmission of information using a same frequency, each of said plurality of terminals comprising a plurality of terminal antenna elements, said base station comprising:
a base station multi-beam antenna comprising a plurality of base station antenna elements; and
an antenna-controlling unit operable to control the space division multiplex wireless transmission via said plurality of base station antenna elements,
wherein said antenna-controlling unit is operable to calculate a plurality of transfer function values determining a radio-wave-propagation characteristic between said plurality of base station antenna elements and said plurality of terminal antenna elements to orthogonalize a beam pattern of said base station multi-beam antenna based on the determined radio-wave-propagation characteristic.

15. The base station as claimed in claim 14, wherein said base station further comprising: an interference amount-estimating unit operable to estimate an interference amount in a pair of propagation paths between said plurality of terminals and said base station,
wherein said antenna-controlling unit is operable to determine a beam pattern of said base station multi-beam antenna based on the interference amount estimated by said interference amount-estimating unit.

16. The base station as claimed in claim 14, wherein said base station further comprising: a mobility-identifying unit operable to identify mobility of each of said plurality of terminals, the mobility indicating degree that one of said plurality of terminals has moved in space per unit time,
wherein said antenna-controlling unit is operable to determine a beam pattern of said base station multi-beam antenna based on the mobility identified by said mobility-identifying unit.

17. A terminal for a wireless communication system comprising a base station and a plurality of terminals, each of said plurality of terminals being composed of said terminal, said plurality of terminals and said base station simultaneously performing space division multiplex wireless transmission of information using a same frequency with each other, said terminal comprising:
a terminal multi-beam antenna comprising a plurality of terminal antenna elements; and
a pilot signal-generating unit operable to generate pilot signals used for estimation of a radio-wave-propagation characteristic between said base station and said terminal,
wherein said terminal multi-beam antenna is operable to transmit to said base station the pilot signals generated by said pilot signal-generating unit.

18. The terminal as claimed in claim 17, wherein said terminal further comprising: an antenna-controlling unit operable to control wireless communications via said plurality of terminal antenna elements, and
wherein said antenna-controlling unit is operable to cancel, after said base station has orthogonalized a beam pattern thereof, an interference wave utilizing at least one of a zero forcing method and a maximum likelihood estimation method.

19. A wireless communication method operable to simultaneously perform space division multiplex wireless transmission of information using a same frequency between a base station and a plurality of terminals, the base station comprising a base station multi-beam antenna including a plurality of base station antenna elements, each of the plurality of terminals comprising a terminal multi-beam antenna including a plurality of terminal antenna elements, said method comprising:
communicating between at least one of the plurality of terminals and the base station via a plurality of propagation paths;
transmitting pilot signals used for estimation of a radio-wave-propagation characteristic from each of the plurality of terminals to the base station;
calculating a plurality of transfer function values of a radio-wave-propagation characteristic between the plurality of base station antenna elements of the base station and the plurality of terminal antenna elements of the plurality of terminals based on the pilot signals; and
orthogonalizing a beam pattern of the base station multi-beam antenna based on the plurality of transfer function values of the radio-wave-propagation characteristic.

20. The wireless communication method as claimed in claim 19, wherein a number of the base station antenna elements is greater than a maximum number of the terminal antenna elements among the plurality of terminals.

21. The wireless communication method as claimed in claim 19, wherein said calculating including calculating eigenvectors of a channel matrix whose matrix elements are composed of the plurality of transfer function values, and
wherein said orthogonalizing including controlling a set of weight to be imposed on the plurality of base station antenna elements using the eigenvectors of the channel matrix.

22. The wireless communication method as claimed in claim 19, wherein said calculating including calculating a plurality of diagonal elements of a channel matrix whose matrix elements are composed of the plurality of transfer function values, and
wherein said orthogonalizing including controlling a set of weight to be imposed on the plurality of base station antenna elements using the plurality of diagonal elements of the channel matrix.

23. The wireless communication method as claimed in claim 19, further comprising: when one of the plurality of terminals has moved, transmitting, from the one of the plurality of terminals to said base station, movement pilot signals to be used for estimating a radio-wave-propagation characteristic between the one of said plurality of terminals and the base station; receiving the movement pilot signals; re-calculating a plurality of transfer function values concerning the one of the plurality of terminals; and orthogonalizing the beam pattern of the base station multi-beam antenna based on the plurality of re-calculated transfer function values.
